(19) United States
(12) Patent Application Publication
(10) Pub. No.: US 2013/0189459 A1
(43) Pub. Date: Jul. 25, 2013

(54) Re-attachable Pipe Insulator

(71) Applicant: Travis Davis, Baytown, TX (US)

(72) Inventor: Travis Davis, Baytown, TX (US)

(21) Appl. No.: 13/356,859

(22) Filed: Jan. 24, 2012

(51) Int. Cl. F16L 59/14; B23P 17/00; F16L 59/02

(52) U.S. Cl. 428/34.1; 29/428; 29/426.5

(57) ABSTRACT

A method of insulating a tube comprising the steps of separating a slit tube insulator to two opposing split tube insulator sides created by radially slitting the tube shaped insulator; covering a tube with the tube insulator; and pressing the slit tube insulator sides together. One of the split tube insulator sides can contain a hook attaching component and the other side can contain a loop attaching component.

### BACKGROUND OF INVENTION

1. Field of Use

This disclosure teaches a pipe or tube insulator device that is attachable and detachable from the tube.

2. Prior Art

Pipe insulation is known. Also known is insulating pipes or tubes with foam materials. The foam insulating materials can be formed in a tubular shaped sections having in inner annulus extending through the longitudinal length of the tube section. One wall of the tube may be slit, thereby allowing the tube shaped insulating section to be opened and slid over a pipe or tube. The insulating material returns to its approximate tubular shape. Any gap at the slit may be closed by a flap or tape. Also the gap may be closed by adhesive material installed on the surfaces formed by slitting the tubular shaped section of insulation.

### SUMMARY OF INVENTION

There is a need for simple reliable mechanism for installing pipe or tube insulation. It will be readily appreciated that insulation forms a thermal barrier between chilled or heated pipe or tube contents and the ambient atmosphere. The piping or tubing (hereinafter “tubing”) can convey hot water for a home or office heating system. The tubing may convey chilled gas for a home or office air conditioning system.

In servicing a heating or air conditioning systems, the technician may be required to remove all or a portion of the insulating material from the tubing. This may be required to repair a leak in the tubing or to monitor the temperature of the contents. Removal of the insulating material may result in the destruction of the material. In such instances, the insulating material has to be replaced. This increases the cost of the work and delays completion of the work.

Frequently the insulation material is made from foam material. It may be purchased with a radially oriented slit extending the longitudinal axis of the tubular shape insulation. The slit extends through the wall of the tube to the inside annulus. The insulation is installed on the tube by separating the slit sufficiently to allow the slit opening to fit over the outside diameter of the tubing. Frequently the installer helically winds tape around the installed insulation, thereby holding the slit closed. Attempted removal of the tape results in deterioration or destruction of the foam insulation.

In other applications, the tubular shaped insulation contains covered adhesive strips on the radial surface of the longitudinally extended slit. The adhesive covering is left in place while the insulation is installed over the tube. The covering is then removed and the adhesive sections bind together, thereby sealing the slit closed. Unfortunately the adhesive structure binds the foam material that the slit can not later be reopened. The foam insulation is destroyed by a later service technician needing to temporarily remove the insulation.

Hook and loop fasteners (sold under the trademark Velcro) have been used with tubular shaped foam insulator materials. The hook and loop components are installed on the outer circumference of the tube shaped insulator. This use of hook and loop components has been in conjunction with a flap that extends over the slit opening. Using the covering involves pulling the edges or surfaces of the slit together and pressing the flap onto the surface of the complementary hook or loop component on the outer tube surface. Frequently, the hook and loop flap configuration has been used with metal foil covered foam insulators. These have the disadvantage of becoming readily bent or dented, resulting in an unsightly appearance. This does not facilitate reuse or recycling of the insulator material.

In another example, hook and loop fasteners are placed on the interior surface of the pipe insulation material. The insulating material is pushed together creating a folded flat structure and the inside surfaces are pressed together. See U.S. Pat. No. 5,055,334 issued to Lechuga.

The present disclosure teaches a tubular shaped insulating material. The insulator has an inner annulus wherein the tube to be insulated can fit. The tubular shaped insulator can be manufactured with an annulus having a dimensioned interior surface to circumvent ½, ¾ inches or other sized pipes. The tubular shaped insulator is manufactured with a radial slit extending along the longitudinal axis. The cutting of the slit creates two surfaces extending radially from the annulus to the outer tube circumference. The surfaces extend the longitudinal length of the insulator section. It will be appreciated that the created surfaces oppose each other. These surfaces are herein after termed “slit tube insulator sides” or “slit sides”.

The present disclosure includes the installation of hook and loop attaching components to the opposing slit tube insulator sides created by the cutting of the slit. The installation of these attachment devices allow the tube shaped insulator to be opened and fitted over the tube. The insulator can then be closed over the tube by pressing together the attachment surfaces, i.e., the slit tube insulator sides.

As is well known, hook and loop fasteners create a strong bond that can be separated or pulled apart and then reattached. The installer can pull open the slit sides, install the insulation material over the tube, and finish the installation by pressing the opposing slit tube insulator sides together. A service technician can later pull apart the hook and loop fasteners attached to the slit tube insulating sides, thereby exposing the tube. The service technician can remove as much of the insulation material as required. Upon completion, the technician again presses the opposing slit tube insulator sides together. Further, the homeowner may seasonally need to insulate pipes. The disclosure allows the homeowner to recycle and reuse the tube insulating material through multiple seasons.

In another embodiment of the invention, the tubular shaped insulator can contain multiple slits. In one embodiment, there may be two slits. This can effectively cut the tubular shaped insulator in half in the longitudinal orientation. Other geometries are possible and are covered by this disclosure. This facilitates installation of the insulator onto the tubing. The halves can be held together by hook and loop attachments.

### SUMMARY OF DRAWINGS

The accompanying drawings, which are incorporated in and constitute a part of the specification, illustrate preferred embodiments of the invention. These drawings, together with the general description of the invention given above and the detailed description of the preferred embodiments given below, serve to explain the principles of the invention.

FIG. 1 illustrates a tubular shaped section of insulation with the slit partially open and the annulus for holding or encircling the tube.

FIG. 2 illustrates tubular shaped insulation of the prior art including a flap extending over the slit opening.

FIG. 3 illustrates the tubular shaped insulation of the prior art with tape wrapped around the outer surface of the tubular insulation and holding the slit closed.

FIG. 4 is a perspective view of the disclosure showing the hook and loop attachments fixed to the slit tube insulator sides.

FIG. 5 is a cross sectional view of the slit tube insulator with the hook and loop attachments fixed to the slit tube insulator sides.

FIG. 6 is a cross sectional view of the slit tube insulator with the opposing slit tube insulator sides pressed closed.

FIG. 7 is a cross section view of an embodiment wherein the tubular shaped insulator is split in half by creation of two slits. The placement of the hook and loop attaching components is also shown.

FIG. 8 is a perspective view of the two piece tubular shaped insulator. Illustrated are a portion of the insulator pressed together and a portion pulled apart.

### DETAILED DESCRIPTION OF THE PRESENT EMBODIMENT

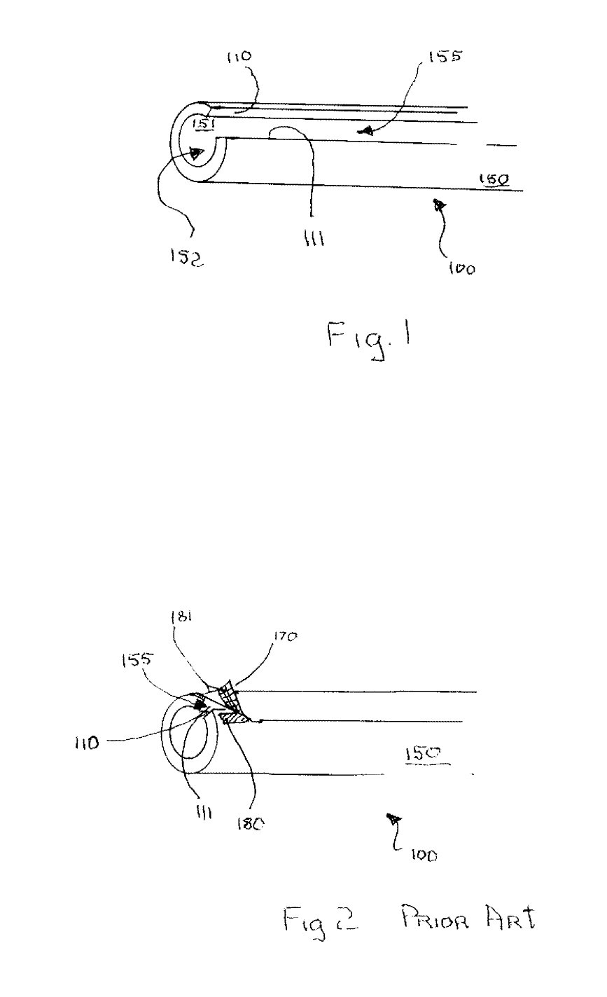

FIG. 1 illustrates tubular shaped tube (or pipe) insulation 100. Illustrated is the open seam or slit 155. The slit is oriented along the longitudinal axis (not shown) of the insulation. Also illustrated are the two slit tube insulator sides 110, 111. The annulus 152 of the tube is illustrated. It will be appreciated that a tube occupies the annulus. This tube (not shown) is insulated. The interior surface 151 of the insulation is illustrated. The outer surface 150 of the insulator is also illustrated. There may be a metal sheath of foil covering the outer surface. There may also be a coating or fabric covering. This foil or fabric may facilitate the insulation of the tube. In one embodiment, not shown, the metal sheath or foil can extend and be flexibly folded over closed junction of the slit tube insulator sides. The foil can later be unfolded to allow the technician or homeowner to pull the hook and loop attachments apart. The foil covering the closed junction of the slit sides may facilitate the insulation of the inner tube. The flexibility of the foil covering facilitates reuse or recycling of the insulator.

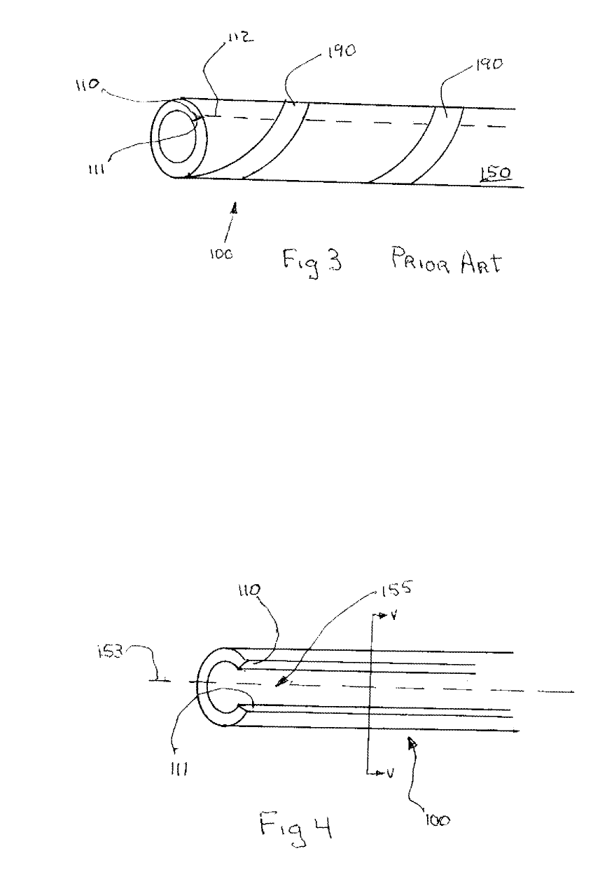

FIG. 2 illustrates a prior art technique for sealing or closing the slit. A flap 170 is attached to the outer surface of the insulator 100. The underside of the flap contains either a hook component or a loop component. The complementary component (hook or loop) is attached to the outer surface 150 of the tube. When the flap 170, containing a hook or loop component 181 is attached to the complementary hook and loop attachment 180, the opening of the split 155 is closed. The surfaces of the slit 110, 111 are pressed together.

FIG. 3 illustrates another prior art technique. The surfaces 110, 111 of the split are pulled together and held in place with tape 190 spiraled on the outside surface 150 of the tubular shaped insulator 100. The line formed of the closed slit sides is illustrated in phantom line 112. It will be appreciated that the tape can not be removed from the insulator without significant damage to the insulation material.

FIG. 4 illustrates a top perspective view of the tubular shaped insulator 100 of the disclosure. The insulator is opened at the split 155 and slit tube insulator sides 110, 111 are clearly visible. The slit tube insulator sides are the surface on which the hook and loop attachments (not shown) can be attached. These attachments may be termed “hook attaching components” and “loop attaching components”. When the tube shaped insulator is closed, the slit tube insulator sides are pressed together. It will be appreciated that the slit follows the longitudinal axis of orientation 153 of the tubular shaped insulator. Also illustrated are the inside surface 151 of the insulator and the annulus 152. The outside surface 150 of the insulator is also illustrated.

FIG. 5 illustrates a cross sectional view of the embodiment illustrated in the perspective view of FIG. 4. Illustrated is the open slit 155 of the tubular shaped insulator 100. Access to the annulus 152 is illustrated. The insulator can fit over the tube to be insulated (not shown). An edgewise view of the slit tube insulator sides 110, 111 and the hook and loop attachments 180, 181 fixed to the surfaces of the slit tube insulator sides is also illustrated. It will be appreciated that one surface, e.g., 110 will contain the hook component and the other surface, e.g., 111 will contain the complementary loop component.

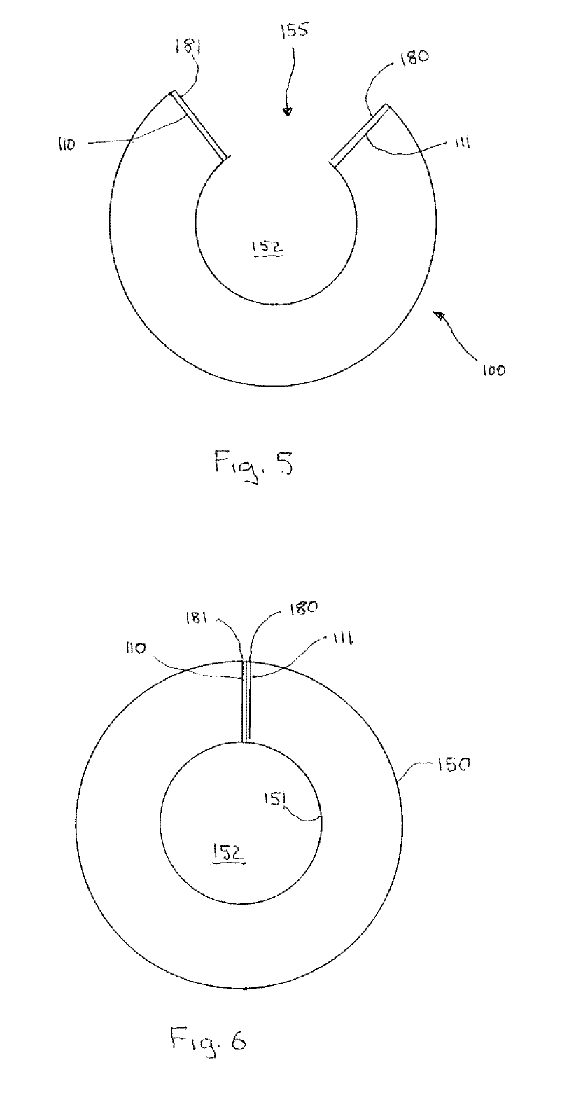

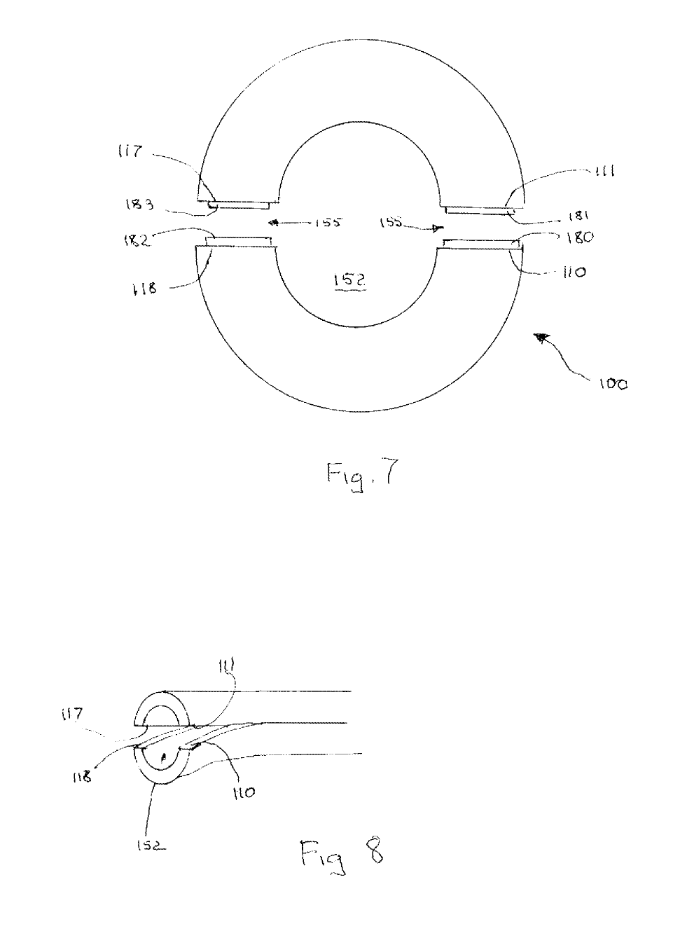

FIG. 6 illustrates a cross sectional view of the tubular shaped insulator with the slit closed. As discussed above, the sides 110, 111 of the slit tube insulator sides are pressed together with the hook and loop components 180, 181 removably attached together. Also illustrated is the inner surface 151 which may be in contact with a tube or pipe occupying the inner annulus 152. Also illustrated is the outer surface 150. It will be appreciated that the outer surface of the insulator of this disclosure does not have any protrusion, ties or flaps that can obstruct the fitting of the tubular shaped insulation through walls or similar structures.

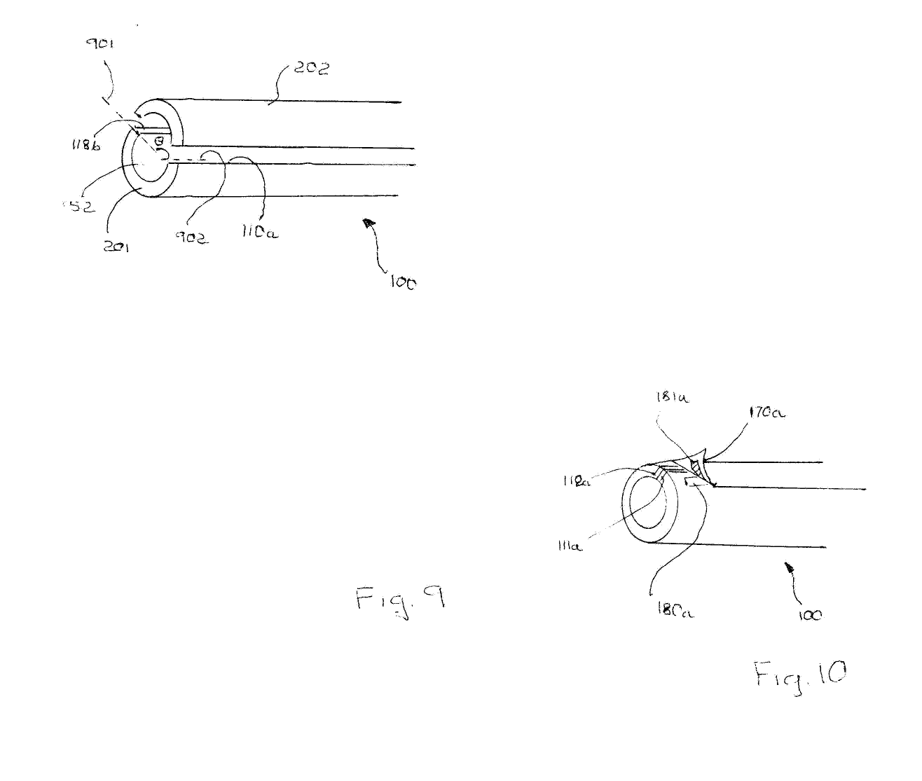

FIG. 7 illustrates another embodiment of the disclosure. The tubular shaped insulator 100 contains two slits 155. It will be appreciated that the slits need not be on the same radial plane. The two slits create four surfaces 110, 111, 117 and 118. Each surface can contain a hook and loop component 180, 181, 182 and 183. In one embodiment, the bottom half of the slit tubular shaped insulator can contain only one type of component, e.g., hook or loop. The top half will contain only the complementary component. This may facilitate installation of the insulator in the field as there will be no need to match edges in a correct orientation. Also illustrated is the annulus 152 that may contain the tube.

FIG. 8 also illustrates the embodiment of the disclosure wherein the tubular shaped insulator contains two slits. The surface 110, 111, 117 and 118 formed by these slits are shown. Also illustrated is the annulus 152 of the tubular shaped insulator.

It will be appreciated that the disclosure does not require banding or taping to close the slit open during installation of the tubular shaped insulator onto the tube. Further the disclosure does not require any ties to hold the slit closed. The disclosure does not require any wrap or fabric material.

This specification is to be construed as illustrative only and is for the purpose of teaching those skilled in the art the manner of carrying out the invention. It is to be understood that the forms of the invention herein shown and described are to be taken as the presently preferred embodiments. As already stated, various changes may be made in the shape, size and arrangement of components or adjustments made in the steps of the method without departing from the scope of this invention. For example, equivalent elements may be substituted for those illustrated and described herein and certain features of the invention maybe utilized independently of the use of other features, all as would be apparent to one skilled in the art after having the benefit of this description of the invention.

While specific embodiments have been illustrated and described, numerous modifications are possible without departing from the spirit of the invention, and the scope of protection is only limited by the scope of the accompanying claims.

What I claim is:

1. A method of insulating a tube comprising the steps of:
(a) opening a tube shaped insulator with two opposing split tube insulator sides;
(b) covering a tube with the tube insulator; and
(c) pressing the slit tube insulator sides together.

2. The method of claim 1 further comprising engaging a loop component fixed to a slit tube insulator side with a hook component fixed to the opposing slit tube insulator side.

3. The method of claim 1 further comprising removal of the slit tube insulator by pulling one slit tube insulator side away from the opposing slit tube insulator side.

4. A method of removeably attaching a tube shaped insulator to a tube comprising:
(a) separating a slit side comprising a hook component of a tube shaped insulator from an opposing slit side comprising a loop component;
(b) covering a tube with the tube shaped insulator having each slit side separated from the other slit side;
(c) pressing the slit sides together to reattach the hook component to the loop component.

5. A detachable and attachable tube shaped insulator comprising:
(a) a tube shaped insulating structure having a longitudinal axis;
(b) a slit extending through a radius of the tube shaped insulating structure wherein the slit creates two surfaces extending along the longitudinal axis of the tube shaped insulator;
(c) a first side comprised of a first surface of the insulating structure created by the slit;
(d) a second side comprised of a second surface created by the slit;
(e) a hook attaching component fixed to the first side; and
(f) a loop attaching component fixed to the second side.

6. The detachable and attachable tube shaped insulator of claim 5 further comprising a flexible foil cover of the outer surface of the insulator wherein the flexible foil extends from a first slit side around the tube shaped insulator to at least the second slit side.

7. The detachable and attachable tube shaped insulator of claim 6 further comprising the flexible foil extending past the second slit side to the first slit side.

8. The detachable and attachable tube shape insulator of claim 7 further comprising the flexible foil folded over a seam formed between the closed first and second slit sides.

9. The detachable and attachable tube shaped insulator of claim 5 further comprising: a second slit extending through the radius of the tube shaped insulating structure wherein each slit creates two surfaces extending along the tube shaped insulator; a first side comprised of a first surface of one slit and a hook component, a second side comprised of a second surface of a first slit and a loop component; a third side comprised a first surface of a second slit and a hook component; and a fourth side comprised of a second surface of a second slit and loop component.

10. The detachable and attachable tube shaped insulator of claim 8 further comprising a first and second slit having the same plane through the tube shaped insulator.

11. The detachable and attachable tube shaped insulator of claim 8 further comprising a first and second slits being oriented on intersecting planes through the tube shape insulator.

12. A detachable and attachable tube shaped insulator comprising:
(a) a tube shaped insulating structure having a longitudinal axis;
(b) a slit extending through a radius of the tube shaped insulating structure wherein the slit creates two surfaces extending along the longitudinal axis of the tube shaped insulator;
(c) a first side comprised of a first surface of the insulating structure created by the slit;
(d) a second side comprised of a second surface created by the slit;
(e) a hook attaching component fixed to the first side; and
(f) a complementary loop attaching component fixed to the second side wherein the hook attaching component can attach to the loop attaching component to hold the first surface and the second surface together.
